(19) United States
(12) Patent Application Publication
(10) Pub. No.: US 2026/0196777 A1
(43) Pub. Date: Jul. 9, 2026

(54) CONNECTOR AND CONNECTOR SET

(71) Applicant: Murata Manufacturing Co., Ltd., Kyoto-fu (JP)

(72) Inventor: Yuma AMEMORI, Nagaokakyo-shi (JP)

(73) Assignee: Murata Manufacturing Co., Ltd., Kyoto-fu (JP)

(21) Appl. No.: 19/558,201

(22) Filed: Mar. 5, 2026

Related U.S. Application Data
(63) Continuation of application No. PCT/JP2024/031422, filed on Sep. 2, 2024.

(30) Foreign Application Priority Data
Sep. 8, 2023 (JP) 2023-145824

(51) Int. Cl. H01R 13/6581

(52) U.S. Cl. CPC H01R 13/6581

(57) ABSTRACT

A connector is configured to be connected to a second connector. The connector includes a body member having an insulating property, a signal terminal, and a first contact terminal connected to a ground potential or a power supply potential. A first direction is defined as a direction that points from the connector to the second connector when the connector and the second connector are connected to each other. The body member includes a projection. The projection has an end face facing in the first direction, and a side face connected to the end face. The contact terminal includes a frame portion, and a terminal portion. The frame portion has the shape of a loop that, as viewed in the first direction, surrounds the periphery of the signal terminal. In a second direction orthogonal to the first direction, the projection is sandwiched between the signal terminal and the terminal portion.

### CROSS-REFERENCE TO RELATED APPLICATIONS

This application claims benefit of priority to International Patent Application No. PCT/JP2024/031422, filed Sep. 2, 2024, and to Japanese Patent Application No. 2023-145824, filed Sep. 8, 2023, the entire contents of each are incorporated herein by reference.

### BACKGROUND

### Technical Field

The present disclosure relates to a connector and a connector set.

### Background Art

A plug connector in International Publication No. 2022/080453 and a first connector in Chinese Utility Model Registration No. 211126218 are known as examples related to connectors in the related art. The plug connector in International Publication No. 2022/080453 is configured to be connected to a receptacle connector. The plug connector and the receptacle connector each have one or more first type contacts, and one or more second type contacts configured to transmit high-frequency signals. Each second type contact of the plug connector protrudes toward the receptacle connector such that the second type contact is held on opposite sides by the corresponding second type contact of the receptacle connector.

A first connector 200 in Chinese Utility Model Registration No. 211126218 is configured to be connected to a second connector 300. The first connector 200 includes an insulating body member 210, high-frequency signal terminals 220A and 220B, low-frequency signal terminals 230, and a shield housing 250. The insulating body member 210 includes a plate-shaped bottom portion 211, and a first protrusion 212 and a second protrusion 214 that protrude from the bottom portion 211. The high-frequency signal terminals 220A and 220B are respectively secured to the first and second protrusions 212 and 214, as shown, for example, in FIGS. 2 and 3 of Chinese Utility Model Registration No. 211126218. When the first connector 200 and the second connector 300 are connected to each other, the high-frequency signal terminals 220A and 220B make contact with high-frequency signal terminals 320A and 320B of the second connector 300, respectively. Each low-frequency signal terminal 230 makes contact with a low-frequency signal terminal 330 of the second connector 300. The shield housing 250 has the shape of a loop so as to surround the high-frequency signal terminals 220A and 220B and the low-frequency signal terminals 230.

### SUMMARY

The structure of the plug connector in International Publication No. 2022/080453 results in reduced mechanical robustness of the plug connector. In particular, in cases such as attempting to miniaturize the plug connector or attempting to make the second type contact of the plug connector transmit signals at higher frequencies, the second type contact of the plug connector has to be made thinner or shorter. This makes the second type contact of the plug connector more susceptible to deformation or breakage upon contact with the receptacle connector. Accordingly, in cases such as attempting to miniaturize the plug connector or attempting to make the second type contact of the plug connector transmit signals at higher frequencies, a decrease in the mechanical robustness of the plug connector becomes particularly pronounced.

According to the structure of the first connector 200 in Chinese Utility Model Registration No. 211126218, the high-frequency signal terminals 220A and 220B are secured to the first and second protrusions 212 and 214, respectively. This allows for improved mechanical robustness as compared with the structure of the plug connector described in International Publication No. 2022/080453. However, the high-frequency signal terminals 220A and 220B are exposed over a large area from the first and second protrusions 212 and 214, respectively. Accordingly, noise emitted by each of the high-frequency signal terminals 220A and 220B may adversely affect signals transmitted by the low-frequency signal terminals 230.

As described above, with existing connectors used to transmit high-frequency signals, it is difficult to provide both mechanical robustness and the ability to shield against noise emitted by a signal terminal.

Accordingly, the present disclosure provides a connector and a connector set that are configured to provide both mechanical robustness and the ability to shield against noise emitted by a signal terminal.

A connector according to an aspect of the present disclosure is a connector to be connected to a second connector. The connector includes a body member having an insulating property; a signal terminal; and a first contact terminal connected to a ground potential or a power supply potential. A first direction is defined as a direction that points from the connector toward the second connector when the connector and the second connector are connected to each other. The body member includes a projection. The projection has an end face facing in the first direction and a side face connected to the end face. The first contact terminal includes a frame portion having a shape of a loop that, as viewed in the first direction, surrounds a periphery of the signal terminal; and a terminal portion. In a second direction orthogonal to the first direction, the projection is sandwiched between the signal terminal and the terminal portion.

The connector and the connector set according to the present disclosure are configured to provide both mechanical robustness and the ability to shield against noise emitted by a signal terminal.

### BRIEF DESCRIPTION OF THE DRAWINGS

FIG. 1 is a perspective view of a connector set when a first connector and a second connector are not connected to each other;

FIG. 2 is a perspective view of the first connector;

FIG. 3 is a perspective view of a first body member;

FIG. 4 is a perspective view of a first contact terminal;

FIG. 5 is a perspective view of first signal terminals;

FIG. 6 is a perspective view of the second connector;

FIG. 7 is a perspective view of a second body member;

FIG. 8 is a perspective view of a second contact terminal;

FIG. 9 is a perspective view of second signal terminals;

FIG. 10 is a cross-sectional view of the connector set;

FIG. 11 is a perspective view of the first contact terminal according to a first modification; and

FIG. 12 is a perspective view of the first contact terminal according to a second modification.

### DETAILED DESCRIPTION

### First Embodiment

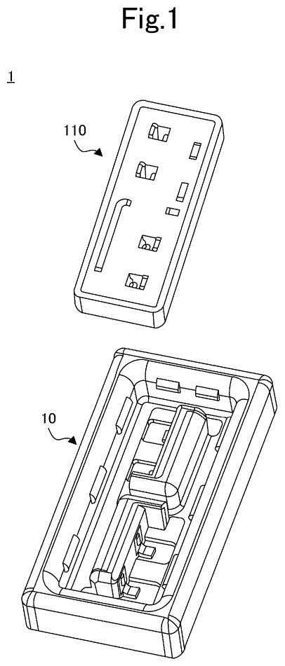

A connector set 1 according to a first embodiment of the present disclosure, which includes a first connector 10, will now be described below with reference to the drawings. FIG. 1 is a perspective view of the connector set 1 when the first connector 10 and a second connector 110 are not connected to each other.

As illustrated in FIG. 1, a direction pointing from the first connector 10 toward the second connector 110 is defined as an upward direction. A direction opposite to the upward direction is defined as a downward direction. The upward direction corresponds to a “first direction” according to the present disclosure.

The connector set 1 is used to connect two components. The components are, for example, circuit boards. As illustrated in FIG. 1, the connector set 1 includes the first connector 10 and the second connector 110. The first connector 10 is configured to be connected to the second connector 110. The first connector 10 corresponds to a “connector” according to the present disclosure.

### Structure of First Connector 10

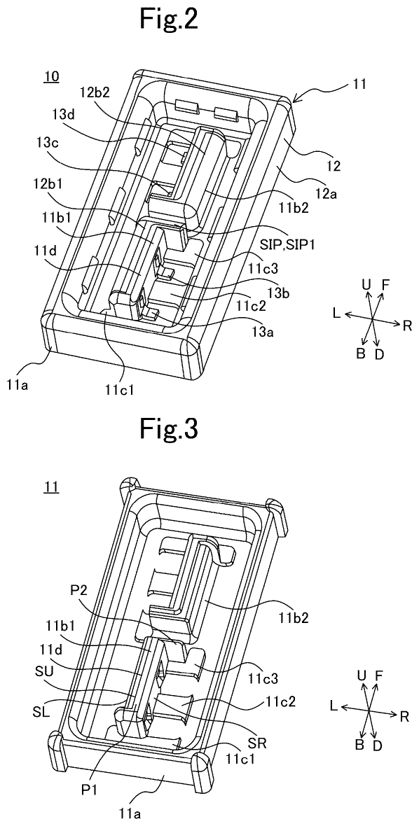

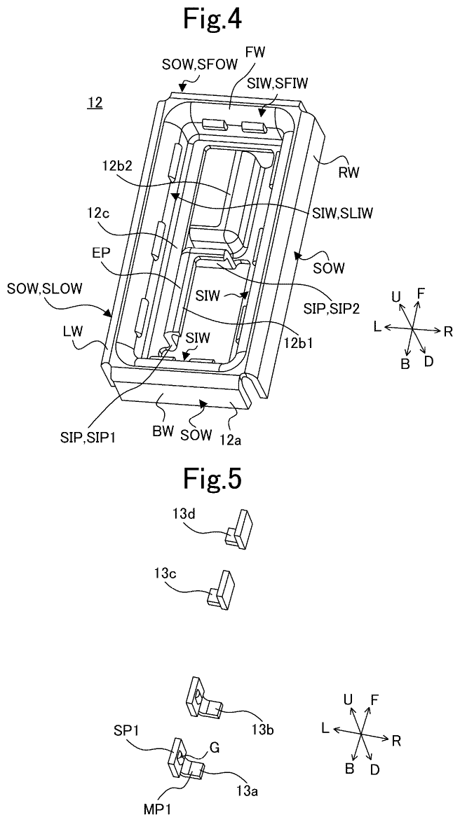

The structure of the first connector 10 will now be described with reference to the drawings. FIG. 2 is a perspective view of the first connector 10. FIG. 3 is a perspective view of a first body member 11. FIG. 4 is a perspective view of a first contact terminal 12. FIG. 5 is a perspective view of first signal terminals 13a to 13d.

As illustrated in FIG. 2, a direction in which first signal terminals 13a and 13b are arranged in this order is defined as a frontward direction. A direction opposite to the frontward direction is defined as a rearward direction. The frontward direction and the rearward direction are orthogonal to the upward direction and the downward direction. The front-rear direction corresponds to a “third direction” and a “fifth direction” according to the present disclosure. A direction orthogonal to the upward direction and the frontward direction and in which a first projection 11b1 of the first body member 11 and the first signal terminal 13a are arranged in this order is defined as a rightward direction. A direction opposite to the rightward direction is defined as a leftward direction. The left-right direction corresponds to a “second direction” and a “fourth direction” according to the present disclosure. The leftward direction corresponds to “one side in the second direction” according to the present disclosure. The rightward direction corresponds to an “other side in the second direction” according to the present disclosure. The “fourth direction” and the “fifth direction” according to the present disclosure need not necessarily coincide with the “second direction” and the “third direction”, respectively. It is to be noted, however, that the upward direction, the downward direction, the frontward direction, the rearward direction, the rightward direction, and the leftward direction are defined herein for the convenience of description. Accordingly, the upward direction, the downward direction, the frontward direction, the rearward direction, the rightward direction, and the leftward direction during actual use of the first connector 10 need not necessarily coincide with these directions as defined herein. Further, in the drawings, the upward direction and the downward direction may be interchanged, the frontward direction and the rearward direction may be interchanged, and the rightward direction and the leftward direction may be interchanged.

As illustrated in FIG. 2, the first connector 10 includes the first body member 11, the first contact terminal 12, and the first signal terminals 13a to 13d. The first body member 11 corresponds to a “body member” according to the present disclosure. The first signal terminals 13a to 13d each correspond to a “signal terminal.” There may be at least one “signal terminal” according to the present disclosure.

As illustrated in FIG. 3, the first body member 11 includes a frame portion 11a, and first projections 11b1 and 11b2. The first body member 11 has an insulating property. According to the present embodiment, the first body member 11 is made of resin. The first body member 11 need not necessarily be made of resin. The first projections 11b1 and 11b2 each correspond to a “projection” according to the present disclosure. There may be at least one “projection” according to the present disclosure.

As illustrated in FIGS. 2 and 3, as viewed in the up-down direction, the frame portion 11a has the shape of a loop surrounding the periphery of the first signal terminals 13a to 13d. The frame portion 11a has a left edge and a right edge that extend in the front-rear direction, and a front edge and a rear edge that extend in the left-right direction.

The first projections 11b1 and 11b2 are arranged in the front-rear direction. According to the present embodiment, the first projection 11b2 has a shape symmetric to that of the first projection 11b1 in the left-right direction and the front-rear direction, and thus will not be described in further detail. The first projection 11b2 need not necessarily have a shape symmetric to that of the first projection 11b1 in the left-right direction and the front-rear direction.

According to the present embodiment, the first projection 11b1 has coupling portions 11b1 to 11b3, and a protruding portion 11d. As viewed in the up-down direction, the coupling portions 11b1 to 11b3 each cover part of the lower face of the region surrounded by the frame portion 11a. As illustrated in FIG. 2, the coupling portions 11b1 to 11b3 each couple the protruding portion 11d and the first contact terminal 12 to each other. The first projection 11b1 need not necessarily have the coupling portions 11b1 to 11b3.

The protruding portion 11d protrudes in the upward direction from the coupling portions 11b1 to 11b3. As illustrated in FIG. 3, according to the present embodiment, the protruding portion 11d has a first portion P1 extending in the front-rear direction, and a second portion P2 extending in the rightward direction from the front end of the first portion P1. The first portion P1 has an upper end face SU that faces in the upward direction, a lower end face that faces in the downward direction, a front side face that faces in the frontward direction, a rear side face that faces in the rearward direction, a right side face SR that faces in the rightward direction, and a left side face SL that faces in the leftward direction. The right side face SR and the left side face SL are each connected to the upper end face SU. According to the present embodiment, the right side face SR of the first portion P1 has two recessed grooves. Each of the two recessed grooves is configured to receive part of the first signal terminal 13a or part of the first signal terminal 13b. The protruding portion 11d need not necessarily have the second portion P2. The number of recessed grooves in the right side face SR of the first portion P1 is not limited to two.

According to the present embodiment, the first contact terminal 12 is connected to a ground potential. As illustrated in FIG. 4, the first contact terminal 12 includes a frame portion 12a, first terminal portions 12b1 and 12b2, and a coupling portion 12c. According to the present embodiment, the first contact terminal 12 is produced by subjecting a plate-shaped metal member to a drawing process. The first contact terminal 12 is made of a copper-based material such as copper phosphate. The first contact terminal 12 is more rigid than the first body member 11. The first contact terminal 12 need not necessarily be connected to a ground potential but may be connected to a power supply potential. The first contact terminal 12 may be produced by subjecting a plate-shaped metal member to a bending process. The first contact terminal 12 need not necessarily be made of a copper-based material such as copper phosphate. The first terminal portions 12b1 and 12b2 each correspond to a “terminal portion” according to the present disclosure. There may be at least one “terminal portion” according to the present disclosure.

As illustrated in FIGS. 2 and 4, as viewed in the up-down direction, the frame portion 12a has the shape of a loop surrounding the periphery of the first signal terminals 13a to 13d. The frame portion 12a has a left wall portion LW and a right wall portion RW that extend in the front-rear direction, and a front wall portion FW and a rear wall portion BW that extend in the left-right direction. Each wall portion has an inner wall face SIW facing internally of the first connector 10 as viewed in the up-down direction, and an outer wall face SOW facing externally of the first connector 10 as viewed in the up-down direction. The term “internally of the first connector 10″ means a direction toward the center of the first connector 10, and the term ”externally of the first connector 10″ means a direction away from the center of the first connector 10. According to the present embodiment, each inner wall face SIW of the frame portion 12a is connected to at least one of the other inner wall faces SIW of the frame portion 12a. For example, a left inner wall face SLIW is connected to a front inner wall face SFIW and a rear inner wall face. The outer wall faces SOW of the frame portion 12a are not connected to each other. For example, a left outer wall face SLOW of the frame portion 12a is connected to none of a front outer wall face SFOW, a rear outer wall face, and a right outer wall face. The frame portion 12a is supported on the frame portion 11a of the first body member 11. According to the present embodiment, the frame portion 12a covers most of the frame portion 11a of the first body member 11. The inner wall faces of the frame portion 12a need not necessarily be connected to each other. The frame portion 12a need not necessarily cover most of the frame portion 11a of the first body member 11. The left wall portion LW corresponds to a “first wall portion” according to the present disclosure. The front wall portion FW corresponds to a “second wall portion” according to the present disclosure. The left inner wall face SLIW corresponds to a “first inner wall face” according to the present disclosure. The front inner wall face SFIW corresponds to a “second inner wall face” according to the present disclosure. The left outer wall face SLOW corresponds to a “first outer wall face” according to the present disclosure. The front outer wall face SFOW corresponds to a “second outer wall face” according to the present disclosure.

As illustrated in FIG. 4, the first terminal portions 12b1 and 12b2 are arranged in the front-rear direction. According to the present embodiment, the first terminal portion 12b2 has a shape symmetric to that of the first terminal portion 12b1 in the left-right direction and the front-rear direction, and thus will not be described in further detail. The first terminal portion 12b2 need not necessarily have a shape symmetric to that of the first terminal portion 12b1 in the left-right direction and the front-rear direction.

As illustrated in FIG. 2, the first terminal portion 12b1 is supported on the protruding portion 11d of the first projection 11b1 of the first body member 11. This will now be explained in more detail. According to the present embodiment, the first terminal portion 12b1 has a side face portion SIP and an end face portion EP as illustrated in FIG. 4. The side face portion SIP and the end face portion EP are connected to each other. The side face portion SIP has a first side face portion SIP1 and a second side face portion SIP2. The first side face portion SIP1 and the second side face portion SIP2 are connected to each other. The side face portion SIP need not necessarily have the second side face portion SIP2.

As illustrated in FIGS. 2 to 4, the first side face portion SIP1 is shaped to be positioned along the left side face SL of the first portion P1. The first side face portion SIP1 thus extends in the front-rear direction. The first side face portion SIP1 is supported on the left side face SL of the first portion P1. According to the present embodiment, the first side face portion SIP1 covers the entire left side face SL of the first portion P1. The second side face portion SIP2 is shaped to be positioned along the front face of the second portion P2. The second side face portion SIP2 thus extends in the left-right direction. The second side face portion SIP2 is supported on the front face of the second portion P2. According to the present embodiment, the second side face portion SIP2 covers the entire front face of the second portion P2. As viewed in the front-rear direction, the second side face portion SIP2 of the first terminal portion 12b1 overlaps the first signal terminals 13a and 13b. The end face portion EP is shaped to be positioned along the upper end face SU of the first portion P1. The end face portion EP is thus supported on the upper end face SU of the first portion P1. According to the present embodiment, the end face portion EP covers the left end portion of the upper end face SU of the first portion P1, and the entire upper face of the second portion P2. The first side face portion SIP1 may cover part of the left side face SL. The second side face portion SIP2 may cover part of the front face of the second portion P2. The end face portion EP need not necessarily cover the entire upper face of the second portion P2, and may cover the entire upper end face SU of the first portion P1.

As viewed in the up-down direction, the coupling portion 12c covers part of the lower face of the region surrounded by the frame portion 12a. The coupling portion 12c couples the frame portion 12a to each of the first terminal portions 12b1 and 12b2. According to the present embodiment, the coupling portion 12c also couples the first terminal portion 12b1 and the first terminal portion 12b2 to each other.

A high-frequency signal is input to or output from each of the first signal terminals 13a to 13d. As illustrated in FIG. 5, the first signal terminals 13a and 13b are arranged in a spaced relationship in the front-rear direction. The first signal terminals 13c and 13d are arranged in a spaced relationship in the front-rear direction. According to the present embodiment, the first signal terminals 13a to 13d are each produced by subjecting a plate-shaped metal member to a bending process. The first signal terminals 13a to 13d are made of a copper-based material such as copper phosphate. Each of the first signal terminals 13a to 13d is more rigid than the first body member 11. According to the present embodiment, the first signal terminal 13b is identical in shape to the first signal terminal 13a, and thus will not be described in further detail. Further, the first signal terminals 13c and 13d each have a shape symmetric to that of the first signal terminal 13a in the left-right direction and the front-rear direction, and thus will not be described in further detail. The first signal terminals 13a to 13d need not necessarily be made of a copper-based material such as copper phosphate. The first signal terminal 13b need not necessarily be identical in shape to the first signal terminal 13a. Each of the first signal terminals 13c and 13d need not necessarily have a shape symmetric to that of the first signal terminal 13a in the left-right direction and the front-rear direction.

The first signal terminal 13a has an L-shape as viewed in the frontward direction. This will now be explained in more detail. The first signal terminal 13a has a first mounting portion MP1 and a first support SP1. The first mounting portion MP1 extends in the left-right direction. When the first connector 10 is mounted to a first circuit board (not illustrated) disposed below the first connector 10, the lower face of the first mounting portion MP1 is electrically connected to an electrode of the first circuit board. The lower face of the first mounting portion MP1 is secured to the electrode of the first circuit board by, for example, solder (not illustrated). The first mounting portion MP1 need not necessarily extend in the left-right direction.

The first support SP1 extends in the upward direction from the left end of the first mounting portion MP1. The first support SP1 is embedded into the corresponding recessed groove provided in the right side face SR of the first portion P1. The first support SP1 is thus supported on the protruding portion 11d of the first projection 11b1 of the first body member 11. Consequently, the first signal terminal 13a is supported on the first body member 11. The right face of the first support SP1 has a recess G that is recessed in the leftward direction. The first support SP1 may be supported on the first body member 11 by being press-fit into the corresponding recessed groove provided in the right side face SR of the first portion P1. The right face of the first support SP1 need not necessarily have the recess G.

### Structure of Second Connector 110

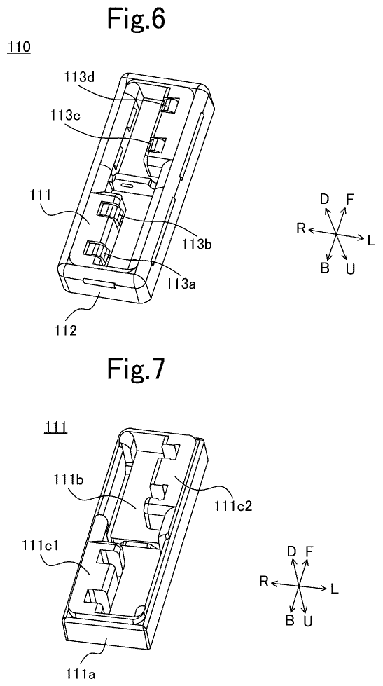

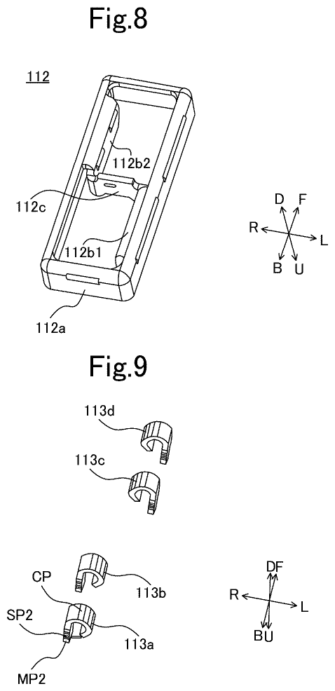

The structure of the second connector 110 will now be described with reference to the drawings. FIG. 6 is a perspective view of the second connector 110. FIG. 7 is a perspective view of a second body member 111. FIG. 8 is a perspective view of a second contact terminal 112. FIG. 9 is a perspective view of second signal terminals 113a to 113d.

As illustrated in FIG. 6, the second connector 110 includes the second body member 111, the second contact terminal 112, and the second signal terminals 113a to 113d.

As illustrated in FIG. 7, the second body member 111 includes a frame portion 111a, a bottom portion 111b, and second projections 111c1 and 111c2. The second body member 111 has an insulating property. According to the present embodiment, the second body member 111 is made of resin. The second body member 111 need not necessarily be made of resin.

As illustrated in FIGS. 6 and 7, as viewed in the up-down direction, the frame portion 111a has the shape of a loop surrounding the periphery of the second signal terminals 113a to 113d. The frame portion 111a has a left edge and a right edge that extend in the front-rear direction, and a front edge and a rear edge that extend in the left-right direction.

As viewed in the up-down direction, the bottom portion 111b covers part of the lower face of the region surrounded by the frame portion 111a.

The second projection 111c1 is provided at the rear portion of the right edge of the frame portion 111a. According to the present embodiment, the left face of the second projection 111c1 has two recessed grooves. Each of the two recessed grooves is configured to receive part of the second signal terminal 113a or part of the second signal terminal 113b. The number of recessed grooves provided in the left face of the second projection 111c1 is not limited to two.

The second projection 111c2 is provided at the front portion of the left edge of the frame portion 111a. According to the present embodiment, the right face of the second projection 111c2 has two recessed grooves. Each of the two recessed grooves is configured to receive part of the second signal terminal 113c or part of the second signal terminal 113d. The number of recessed grooves provided in the right face of the second projection 111c2 is not limited to two.

According to the present embodiment, the second contact terminal 112 is connected to a ground potential. As illustrated in FIG. 8, the second contact terminal 112 includes a frame portion 112a, second terminal portions 111b1 and 112b2, and a coupling portion 112c. According to the present embodiment, the second contact terminal 112 is produced by subjecting a plate-shaped metal member to a drawing process. The second contact terminal 112 is made of a copper-based material such as copper phosphate. The second contact terminal 112 need not necessarily be connected to a ground potential but may be connected to a power supply potential. The second contact terminal 112 may be produced by subjecting a plate-shaped metal member to a bending process. The second contact terminal 112 need not necessarily be made of a copper-based material such as copper phosphate.

As illustrated in FIGS. 6 and 8, as viewed in the up-down direction, the frame portion 112a has the shape of a loop surrounding the periphery of the second signal terminals 113a to 113d. The frame portion 112a has a left edge and a right edge that extend in the front-rear direction, and a front edge and a rear edge that extend in the left-right direction. The frame portion 112a is supported on the frame portion 111a of the second body member 111. According to the present embodiment, the frame portion 112a covers most of the frame portion 111a of the second body member 111. The frame portion 112a need not necessarily cover most of the frame portion 111a of the second body member 111.

As illustrated in FIG. 8, the second terminal portion 112b1is provided at the rear portion of the left edge of the frame portion 112a. The second terminal portion 112b2 is provided at the front portion of the right edge of the frame portion 112a.

The coupling portion 112c has the shape of a plate extending in the left-right direction. The coupling portion 112c couples the front end of the second terminal portion 112b1, and the rear end of the second terminal portion 112b2 to each other.

A high-frequency signal is input to or output from each of the second signal terminals 113a to 113d. As illustrated in FIG. 9, the second signal terminals 113a and 113b are arranged in a spaced relationship in the front-rear direction. The second signal terminals 113c and 113d are arranged in a spaced relationship in the front-rear direction. According to the present embodiment, the second signal terminal 113b is identical in shape to the second signal terminal 113a, and thus will not be described in further detail. Further, the second signal terminals 113c and 113d each have a shape symmetric to that of the second signal terminal 113a in the left-right direction and the front-rear direction, and thus will not be described in further detail. The second signal terminal 113b need not necessarily be identical in shape to the second signal terminal 113a. Each of the second signal terminals 113c and 113d need not necessarily have a shape symmetric to that of the second signal terminal 113a in the left-right direction and the front-rear direction.

According to the present embodiment, the second signal terminal 113a has a shape that is curved in the upward direction. More specifically, the second signal terminal 113a has a second mounting portion MP2, a second support SP2, and a curved portion CP. When the second connector 110 is mounted to a second circuit board (not illustrated) disposed above the second connector 110, the upper face of the second mounting portion MP2 is electrically connected to an electrode of the second circuit board. The upper face of the second mounting portion MP2 is secured to the electrode of the second circuit board by, for example, solder (not illustrated). The second mounting portion MP2 need not necessarily extend in the up-down direction.

The second support SP2 extends in the downward direction from the lower end of the second mounting portion MP2. According to the present embodiment, the width in the front-rear direction of the second support SP2 is greater than the width in the front-rear direction of a portion of the second signal terminal 113a other than the second support SP2. The second support SP2 is press-fit into the corresponding recessed groove provided in the left face of the second projection 111c1. The second support SP2 is thus supported on the second body member 111. Consequently, the second signal terminal 113a is supported on the second body member 111. The width in the front-rear direction of the second support SP2 need not necessarily be greater than the width in the front-rear direction of a portion of the second signal terminal 113a other than the second support SP2. The second support SP2 may be supported on the second body member 111 by being embedded into the corresponding recessed groove provided in the left face of the second projection 111c1.

The curved portion CP has a shape that is curved in the upward direction from the upper end of the second support SP2. The distal end of the curved portion CP is a free end that is not connected to any other component of the second connector 110.

### Structure of Connector Set 1

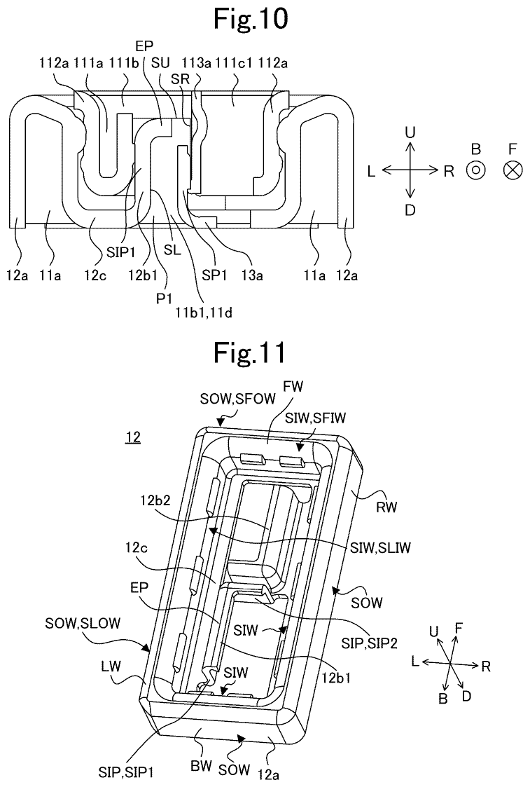

The structure of the connector set 1 will now be described with reference to the drawings. FIG. 10 is a cross-sectional view of the connector set 1. The cross-section of the connector set 1 in FIG. 10 is a plane passing through the first signal terminal 13a and orthogonal to the front-rear direction.

As illustrated in FIG. 1, with the first connector 10 viewed in the up-down direction, the second body member 111 of the second connector 110 is inserted into the region surrounded by the frame portion 11a of the first connector 10. The first connector 10 is connected to the second connector 110 in the up-down direction. According to the present embodiment, when the first connector 10 and the second connector 110 are connected to each other, the direction pointing from the first connector 10 toward the second connector 110 is the upward direction. At this time, as viewed in the up-down direction, the frame portion 11a of the first connector 10, and the frame portion 111a of the second connector 110 do not overlap each other. Further, as viewed in the up-down direction, the respective protruding portions 11d of the first and second projections 11b1 and 11b2 of the first connector 10, and the second projections 111c1 and 111c2 of the second connector 110 do not overlap each other. When the first connector 10 and the second connector 110 are connected to each other, the second side face portion SIP2 of the first terminal portion 12b1 of the first connector 10 is connected to the second contact terminal 112 of the second connector 110. More specifically, when the first connector 10 and the second connector 110 are connected to each other, the second contact terminal 112 of the second connector 110 becomes sandwiched between the first projections 11b1 and 11b2 of the first connector 10. The first contact terminal 12 of the first connector 10 is thus connected to the second contact terminal 112 of the second connector 110.

As illustrated in FIG. 10, the first contact terminal 12 and the first signal terminal 13a are supported on the protruding portion 11d of the first projection 11b1. The first projection 11b1 is sandwiched between the first signal terminal 13a and the first terminal portion 12b1 of the first contact terminal 12 in the left-right direction. The first side face portion SIP1 of the first contact terminal 12 covers the entire left side face SL of the first portion P1 of the protruding portion 11d of the first projection 11b1. The end face portion EP of the first contact terminal 12 covers the left end portion of the upper end face SU of the first portion P1 of the protruding portion 11d of the first projection 11b1. The first support SP1 of the first signal terminal 13a covers part of the right side face SR of the first portion P1 of the protruding portion 11d of the first projection 11b1. The upper end face SU of the first portion P1 of the protruding portion 11d of the first projection 11b1 is located above the first signal terminal 13a. Accordingly, the first signal terminal 13a is not exposed from the upper end face SU of the first portion P1 of the protruding portion 11d of the first projection 11b1. The upper end of the first contact terminal 12 is located above the first signal terminal 13a.

When the first connector 10 and the second connector 110 are connected to each other, the first signal terminals 13a to 13d of the first connector 10 are respectively connected to the second signal terminals 113a to 113d of the second connector 110. At this time, the respective curved portions CP of the second signal terminals 113a to 113d make contact at their distal ends with the recesses G provided in the respective right faces of the first supports SP1 of the first signal terminals 13a to 13d. The first signal terminals 13a to 13d are thus electrically connected to the second signal terminals 113a to 113d, respectively. Further, the respective distal ends of the curved portions CP of the second signal terminals 113a to 113d become caught in the recesses G provided in the respective right faces of the first supports SP1 of the first signal terminals 13a to 13d. This reduces the likelihood of disconnection between the first signal terminals 13a to 13d and the corresponding second signal terminals 113a to 113d. The first contact terminal 12 of the first connector 10 is connected to the second contact terminal 112 of the second connector 110.

### Advantageous Effects

The first connector 10 is configured to provide both mechanical robustness and the ability to shield against noise emitted by a signal terminal. This will now be explained in more detail. The first signal terminal 13a and the first contact terminal 12 are more rigid than the first body member 11. In the left-right direction, the first projection 11b1 is sandwiched between the first signal terminal 13a and the first terminal portion 12b1 of the first contact terminal 12. The first signal terminal 13a and the first contact terminal 12 thus protect the first projection 11b1 from a force acting in the left-right direction. This helps to ensure the mechanical robustness of the first projection 11b1. Therefore, the first connector 10 has enhanced mechanical robustness.

Since the first projection 11b1 is sandwiched between the first signal terminal 13a and the first terminal portion 12b1 of the first contact terminal 12 in the left-right direction, the first terminal portion 12b1 provides shielding against noise emitted by the first signal terminal 13a. This results in an enhanced ability of the first connector 10 to shield against noise emitted by the signal terminal. As a result, the first connector 10 is configured to provide both mechanical robustness and the ability to shield against noise emitted by the signal terminal.

As described above, the first connector 10 is configured to ensure the mechanical robustness of the first projection 11b1. This makes it possible to reduce the length in the left-right direction between the frame portion 111a of the second body member 111 and the second projection 111c1. Accordingly, the second connector 110 can be reduced in length in the left-right direction. This makes it possible to reduce the length of the first connector 10 in the left-right direction. This in turn makes it possible to miniaturize the first connector 10.

The first connector 10 is configured to further improve the ability to shield against noise emitted by a signal terminal. This will now be explained in more detail. The first terminal portion 12b1 has the side face portion SIP that is supported on the left side face SL of the first portion P1, and the end face portion EP that is supported on the upper end face SU of the first portion P1. Consequently, the side face portion SIP and the end face portion EP both provide shielding against noise emitted by the first signal terminal 13a. According to the present embodiment, the first terminal portion 12b1 of the first contact terminal 12 is located to the left of the first signal terminal 13a. Accordingly, the first terminal portion 12b1 of the first contact terminal 12 provides shielding against not only noise emitted in the leftward direction by the first signal terminal 13a but also noise emitted in the upper-left direction by the first signal terminal 13a. This allows the first connector 10 to further improve the ability to shield against noise emitted by the signal terminal.

The first connector 10 is configured to provide further improved mechanical robustness. This will now be explained in more detail. The coupling portion 12c couples the frame portion 12a and the first terminal portion 12b1 to each other. This improves the rigidity of the first terminal portion 12b1. For example, even when the first terminal portion 12b1 is subjected to an external impact, the frame portion 12a absorbs the impact. This allows the first connector 10 to provide further improved mechanical robustness.

The first connector 10 is configured to provide further improved mechanical robustness. This will now be explained in more detail. Each inner wall face SIW of the frame portion 12a is connected to at least one of the other inner wall faces SIW of the frame portion 12a. This improves the rigidity of the frame portion 12a. This allows the first connector 10 to provide further improved mechanical robustness.

The first connector 10 is configured to further improve the ability to shield against noise emitted by a signal terminal. This will now be explained in more detail. As viewed in the front-rear direction, the second side face portion SIP2 of the first terminal portion 12b1 of the first contact terminal 12 overlaps the first signal terminal 13a. According to the present embodiment, the second side face portion SIP2 of the first terminal portion 12b1 of the first contact terminal 12 is located frontward relative to the first signal terminal 13a. Accordingly, the first terminal portion 12b1 of the first contact terminal 12 provides shielding against not only noise emitted in the leftward direction by the first signal terminal 13a but also noise emitted in the frontward direction by the first signal terminal 13a. This makes it possible to further improve the ability to shield against noise emitted by the signal terminal. Further, when the first connector 10 and the second connector 110 are connected to each other, the second side face portion SIP2 is connected to the second contact terminal 112 of the second connector 110. This makes it possible to further improve the ability to shield against noise emitted by the signal terminal. This allows the first connector 10 to further improve the ability to shield against noise emitted by the signal terminal.

The first connector 10 is configured to provide further improved mechanical robustness. This will now be explained in more detail. The first side face portion SIP1 is connected to the second side face portion SIP2. This improves the rigidity of the first terminal portion 12b1. This allows the first connector 10 to provide further improved mechanical robustness.

The first connector 10 is configured to further improve the ability to shield against noise emitted by a signal terminal. This will now be explained in more detail. The upper end face SU of the first portion P1 is located above the first signal terminal 13a. Accordingly, the end face portion EP of the first contact terminal 12 is located above the first signal terminal 13a. The first contact terminal 12 thus provides shielding against noise emitted in the upper-left direction by the first signal terminal 13a. This allows the first connector 10 to further improve the ability to shield against noise emitted by the signal terminal.

### First Modification

A first connector 10a according to a first modification of the present disclosure will now be described with reference to the drawings. FIG. 11 is a perspective view of the first contact terminal 12 according to the first modification. As for the first connector 10a according to the first modification, only its features different from those of the first connector 10 according to the first embodiment will be described, and the remaining features will not be described in further detail.

The first connector 10a according to the first modification differs from the first connector 10 according to the first embodiment in the shape of the frame portion 12a of the first contact terminal 12.

According to the present modification, as illustrated in FIG. 11, each outer wall face SOW of the frame portion 12a is connected to at least one of the other outer wall faces SOW of the frame portion 12a. For example, the left outer wall face SLOW is connected to the front outer wall face SFOW and the rear outer wall face.

The first connector 10a configured as described above provides the same advantageous effects as those of the first connector 10. The first connector 10a is also configured to provide further improved mechanical robustness. This will now be explained in more detail. Each outer wall face SOW of the frame portion 12a of the first contact terminal 12 is connected to at least one of the other outer wall faces SOW of the frame portion 12a. This improves the rigidity of the frame portion 12a of the first contact terminal 12. This in turn allows the first connector 10a to provide further improved mechanical robustness.

### Second Modification

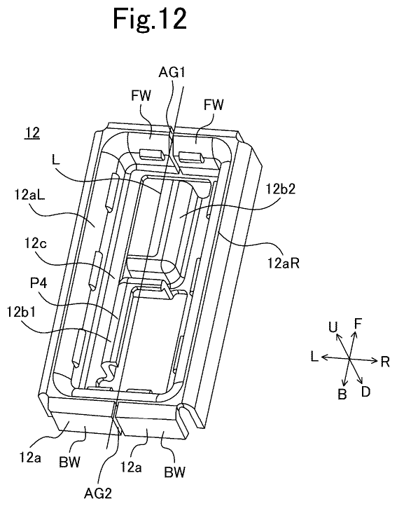

A first connector 10b according to a second modification of the present disclosure will now be described with reference to the drawings. FIG. 12 is a perspective view of the first contact terminal 12 according to the second modification. As for the first connector 10b according to the second modification, only its features different from those of the first connector 10 according to the first embodiment will be described, and the remaining features will not be described in further detail.

The first connector 10b according to the second modification differs from the first connector 10 according to the first embodiment in the shape of the frame portion 12a of the first contact terminal 12.

According to the present modification, as illustrated in FIG. 12, the frame portion 12a is divided into a first frame portion 12aL and a second frame portion 12aR. More specifically, a first air gap AG1 is provided in the middle of the front wall portion FW of the frame portion 12a, and a second air gap AG2 is provided in the middle of the rear wall portion BW of the frame portion 12a. The first frame portion 12aL and the second frame portion 12aR are thus not connected to each other. The first frame portion 12aL has a shape symmetric to that of the second frame portion 12aR in the left-right direction. In other words, the first frame portion 12aL has a shape that is line-symmetric to that of the second frame portion 12aR with respect to a straight line L extending in the front-rear direction.

The first frame portion 12aL is located to the left relative to the first projections 11b1 and 11b2 of the first body member 11. Further, as viewed in the left-right direction, the first frame portion 12aL is positioned to overlap the first projections 11b1 and 11b2. The second frame portion 12aR is located to the right relative to the first projections 11b1 and 11b2. Further, as viewed in the left-right direction, the second frame portion 12aR is positioned to overlap the first projections 11b1 and 11b2.

The first connector 10b configured as described above provides the same advantageous effects as those of the first connector 10. The first connector 10b is also configured to provide further improved mechanical robustness. This will now be explained in more detail. The frame portion 12a is divided into the first frame portion 12aL and the second frame portion 12aR. This improves the elasticity of the frame portion 12a as compared with when the frame portion 12a is provided as a single frame portion. This in turn allows the frame portion 12a to absorb a greater impact. Further, the first frame portion 12aL is located to the left relative to the first projection 11b1 of the first body member 11. Further, as viewed in the left-right direction, the first frame portion 12aL is positioned to overlap the first projection 11b1. As a result, even when the first projection 11b1 is subjected to a leftward impact force, the first frame portion 12aL absorbs the impact. Further, the second frame portion 12aR is located to the right relative to the first projection 11b1 of the first body member 11. Further, as viewed in the left-right direction, the second frame portion 12aR is positioned to overlap the first projection 11b1. As a result, even when the first projection 11b1 is subjected to a rightward impact force, the second frame portion 12aR absorbs the impact. Furthermore, the first frame portion 12aL has a shape that is line-symmetric to that of the second frame portion 12aR with respect to the straight line L extending in the front-rear direction. Therefore, the first connector 10b is configured such that the leftward impact force that can be absorbed by the first frame portion 12aL and the rightward impact force that can be absorbed by the second frame portion 12aR are equal in magnitude. This reduces the likelihood that the first connector 10b is vulnerable to one of the leftward and rightward forces. This allows the first connector 10b to provide further improved mechanical robustness.

### Other Embodiments

The connector according to the present disclosure is not limited to the first connectors 10, 10a, and 10b but may be subject to changes within the scope of the present disclosure. The structural features of the first connectors 10, 10a, and 10b may be combined in any desired manner.

The connector set according to the present disclosure is not limited to the connector set 1 but may be subject to changes within the scope of the present disclosure.

The present disclosure has features described below.
(1) A connector to be connected to a second connector, the connector comprising a body member having an insulating property; a signal terminal; and a first contact terminal connected to a ground potential or a power supply potential. A first direction is defined as a direction that points from the connector toward the second connector when the connector and the second connector are connected to each other. The body member includes a projection, the projection having an end face facing in the first direction and a side face connected to the end face. The first contact terminal includes a frame portion having a shape of a loop that, as viewed in the first direction, surrounds a periphery of the signal terminal, and a terminal portion. Also, in a second direction orthogonal to the first direction, the projection is sandwiched between the signal terminal and the terminal portion.
(2) The connector according to (1), wherein the terminal portion has a side face portion supported on the side face, and an end face portion connected to the side face portion and supported on the end face.
(3) The connector according to (1) or (2), wherein the first contact terminal includes a coupling portion that couples the frame portion and the terminal portion to each other.
(4) The connector according to any one of (1) to (3), wherein the frame portion has a first wall portion extending in a third direction orthogonal to the first direction, and a second wall portion extending in a fourth direction orthogonal to the first direction and to the third direction. The first wall portion has a first inner wall face that, as viewed in the first direction, faces internally of the connector, the second wall portion has a second inner wall face that, as viewed in the first direction, faces internally of the connector, and the first inner wall face is connected to the second inner wall face.
(5) The connector according to any one of (1) to (4), wherein the frame portion has a first wall portion extending in a third direction orthogonal to the first direction, and a second wall portion extending in a fourth direction orthogonal to the first direction and to the third direction. The first wall portion has a first outer wall face that, as viewed in the first direction, faces externally of the connector, the second wall portion has a second outer wall face that, as viewed in the first direction, faces externally of the connector, and the first outer wall face is connected to the second outer wall face.
(6) The connector according to (2), wherein the side face portion has a first side face portion extending in a fifth direction orthogonal to the first direction and to the second direction, and a second side face portion extending in the second direction. Also, as viewed in the fifth direction, the second side face portion overlaps the signal terminal, and when the connector and the second connector are connected to each other, the second side face portion is connected to a second contact terminal of the second connector.
(7) The connector according to (6), wherein the first side face portion is connected to the second side face portion.
(8) The connector according to any one of (1) to (7), wherein the frame portion is divided into a first frame portion and a second frame portion. The first frame portion is located at one side in the second direction relative to the projection and, as viewed in the second direction, overlaps the projection, the second frame portion is located at an other side in the second direction relative to the projection and, as viewed in the second direction, overlaps the projection, and the first frame portion has a shape that is line-symmetric to a shape of the second frame portion with respect to a straight line, the straight line extending in a fifth direction orthogonal to the first direction and to the second direction.
(9) The connector according to any one of (1) to (8), wherein the end face is located in the first direction relative to the signal terminal.
(10) A connector set comprising the connector according to any one of (1) to (9); and the second connector.

What is claimed is:

1. A connector to be connected to a second connector, the connector comprising:
a body member having an insulating property;
a signal terminal; and
a first contact terminal connected to a ground potential or a power supply potential,
wherein
a first direction is defined as a direction that points from the connector toward the second connector when the connector and the second connector are connected to each other,
the body member includes a projection, the projection having an end face facing in the first direction and a side face connected to the end face,
the first contact terminal includes
a frame portion having a shape of a loop that, as viewed in the first direction, surrounds a periphery of the signal terminal, and
a terminal portion, and
in a second direction orthogonal to the first direction, the projection is sandwiched between the signal terminal and the terminal portion.

2. The connector according to claim 1, wherein
the terminal portion has
a side face portion supported on the side face, and
an end face portion connected to the side face portion and supported on the end face.

3. The connector according to claim 1, wherein
the first contact terminal includes a coupling portion that couples the frame portion and the terminal portion to each other.

4. The connector according to claim 1, wherein
the frame portion has
a first wall portion extending in a third direction orthogonal to the first direction, and
a second wall portion extending in a fourth direction orthogonal to the first direction and to the third direction,
wherein
the first wall portion has a first inner wall face that, as viewed in the first direction, faces internally of the connector,
the second wall portion has a second inner wall face that, as viewed in the first direction, faces internally of the connector, and
the first inner wall face is connected to the second inner wall face.

5. The connector according to claim 1, wherein
the frame portion has
a first wall portion extending in a third direction orthogonal to the first direction, and
a second wall portion extending in a fourth direction orthogonal to the first direction and to the third direction,
wherein
the first wall portion has a first outer wall face that, as viewed in the first direction, faces externally of the connector,
the second wall portion has a second outer wall face that, as viewed in the first direction, faces externally of the connector, and
the first outer wall face is connected to the second outer wall face.

6. The connector according to claim 2, wherein
the side face portion has
a first side face portion extending in a fifth direction orthogonal to the first direction and to the second direction, and
a second side face portion extending in the second direction,
as viewed in the fifth direction, the second side face portion overlaps the signal terminal, and
when the connector and the second connector are connected to each other, the second side face portion is connected to a second contact terminal of the second connector.

7. The connector according to claim 6, wherein the first side face portion is connected to the second side face portion.

8. The connector according to claim 1, wherein
the frame portion is divided into a first frame portion and a second frame portion,
the first frame portion is at one side in the second direction relative to the projection and, as viewed in the second direction, overlaps the projection,
the second frame portion is at an other side in the second direction relative to the projection and, as viewed in the second direction, overlaps the projection, and
the first frame portion has a shape that is line-symmetric to a shape of the second frame portion with respect to a straight line, the straight line extending in a fifth direction orthogonal to the first direction and to the second direction.

9. The connector according to claim 1, wherein the end face is located in the first direction relative to the signal terminal.

10. A connector set comprising:
the connector according to claim 1; and
the second connector.

11. The connector according to claim 2, wherein
the first contact terminal includes a coupling portion that couples the frame portion and the terminal portion to each other.

12. The connector according to claim 2, wherein
the frame portion has
a first wall portion extending in a third direction orthogonal to the first direction, and
a second wall portion extending in a fourth direction orthogonal to the first direction and to the third direction,
wherein
the first wall portion has a first inner wall face that, as viewed in the first direction, faces internally of the connector,
the second wall portion has a second inner wall face that, as viewed in the first direction, faces internally of the connector, and
the first inner wall face is connected to the second inner wall face.

13. The connector according to claim 3, wherein
the frame portion has
a first wall portion extending in a third direction orthogonal to the first direction, and
a second wall portion extending in a fourth direction orthogonal to the first direction and to the third direction,
wherein
the first wall portion has a first inner wall face that, as viewed in the first direction, faces internally of the connector,
the second wall portion has a second inner wall face that, as viewed in the first direction, faces internally of the connector, and
the first inner wall face is connected to the second inner wall face.

14. The connector according to claim 2, wherein
the frame portion has
a first wall portion extending in a third direction orthogonal to the first direction, and
a second wall portion extending in a fourth direction orthogonal to the first direction and to the third direction,
wherein
the first wall portion has a first outer wall face that, as viewed in the first direction, faces externally of the connector,
the second wall portion has a second outer wall face that, as viewed in the first direction, faces externally of the connector, and
the first outer wall face is connected to the second outer wall face.

15. The connector according to claim 3, wherein
the frame portion has
a first wall portion extending in a third direction orthogonal to the first direction, and
a second wall portion extending in a fourth direction orthogonal to the first direction and to the third direction,
wherein
the first wall portion has a first outer wall face that, as viewed in the first direction, faces externally of the connector,
the second wall portion has a second outer wall face that, as viewed in the first direction, faces externally of the connector, and
the first outer wall face is connected to the second outer wall face.

16. The connector according to claim 2, wherein
the frame portion is divided into a first frame portion and a second frame portion,
the first frame portion is at one side in the second direction relative to the projection and, as viewed in the second direction, overlaps the projection,
the second frame portion is at an other side in the second direction relative to the projection and, as viewed in the second direction, overlaps the projection, and
the first frame portion has a shape that is line-symmetric to a shape of the second frame portion with respect to a straight line, the straight line extending in a fifth direction orthogonal to the first direction and to the second direction.

17. The connector according to claim 3, wherein
the frame portion is divided into a first frame portion and a second frame portion,
the first frame portion is at one side in the second direction relative to the projection and, as viewed in the second direction, overlaps the projection,
the second frame portion is at an other side in the second direction relative to the projection and, as viewed in the second direction, overlaps the projection, and
the first frame portion has a shape that is line-symmetric to a shape of the second frame portion with respect to a straight line, the straight line extending in a fifth direction orthogonal to the first direction and to the second direction.

18. The connector according to claim 2, wherein the end face is located in the first direction relative to the signal terminal.

19. The connector according to claim 3, wherein the end face is located in the first direction relative to the signal terminal.

20. A connector set comprising:
the connector according to claim 2; and
the second connector.
